(19) United States
(12) Patent Application Publication
(10) Pub. No.: US 2026/0333225 A1
(43) Pub. Date: Oct. 22, 2026

(54) SUBGROUPING METHOD AND APPARATUS FOR ULTRALOW-POWER CONSUMPTION OF IoT TERMINALS IN WIRELESS ENVIRONMENTS

(71) Applicant: ELECTRONICS AND TELECOMMUNICATIONS RESEARCH INSTITUTE, Daejeon (KR)

(72) Inventors: Min-Suk CHOI, Daejeon (KR); Jae-Deok LIM, Daejeon (KR); Jeong-Nyeo KIM, Daejeon (KR)

(21) Appl. No.: 19/393,283

(22) Filed: Nov. 18, 2025

(30) Foreign Application Priority Data
Apr. 17, 2025 (KR) 10-2025-0049847
Jul. 31, 2025 (KR) 10-2025-0105339

(51) Int. Cl. H04W 52/02

(52) U.S. Cl. CPC H04W 52/0235; H04W 52/0219

(57) ABSTRACT

Disclosed herein is a subgrouping apparatus and method for ultralow-power consumption of an IoT terminal in a wireless environment. A user equipment for wireless communication includes a main radio (MR) receiver for receiving a wake-up signal (WUS) configuration from a base station, a Low Power (LP) receiver for receiving a WUS from the base station, and a control unit form monitoring a WUS associated with the ID of the WUS subgroup to which the user equipment (UE) belongs, based on the WUS configuration, and the ID of the LP-WUS subgroup may be determined based on the UE_ID of the UE and a predefined number for power saving for each time period (T).

### CROSS REFERENCE TO RELATED APPLICATIONS

This application claims the benefit of Korean Patent Applications No. 10-2025-0049847, filed Apr. 17, 2025, and No. 10-2025-0105339, filed Jul. 31, 2025, which are hereby incorporated by reference in their entireties into this application.

### BACKGROUND OF THE INVENTION

### 1. Technical Field

The present disclosure relates to a subgrouping method and apparatus for ultralow-power consumption of IoT terminals in wireless environments.

The present disclosure relates to security inspection automation technology for rapidly and conveniently checking security vulnerabilities and formal-verification-based security verification technology for ensuring a high level of security and safety in order to securely protect IoT/IIoT devices in the IoT field, especially in the mission-critical field closely related to the lives, safety, and property of the public, and it relates to user equipment subgrouping technology for reducing a paging false alarm rate based on a Paging Early Indication (PEI) in order to minimize incorrect transmission and reception of a Low Power Wake-Up Signal (LP-WUS) used to wake up a terminal in a sleep state in a method for reducing the power consumption of a terminal such that a high-reliability-assured IoT/IIoT device, to which such formal verification is applied, can provide services for a longer period with minimum power when operated in an actual field.

### 2. Description of the Related Art

In order to create and provide new and diverse services worldwide, the demand and supply for the Internet of Things (IoT), which can closely connect objects, people, and spaces to transmit and receive information by digitizing service content, are increasing. In response to the demand for IoT, IoT devices are being developed and advanced, and the number thereof is increasing exponentially. IoT technology has been expanding into a wide range of application fields, including public industries such as manufacturing, smart cities, healthcare, education, and the like. IoT devices in various forms, such as mobile devices, wearable devices, home appliances, and the like, are applied to real life based on small sensors, computer devices, and wired/wireless network technology and continue to evolve into more diverse forms to expand their application fields. Globally, the number of IoT devices is expected to increase to 25.4 billion by 2030, and companies and research institutions that develop and study IoT devices are conducting research on intelligent IoT technology capable of not only connecting devices to collect data but also analyzing the collected data and providing the analysis results to application services.

Various studies are being conducted on IoT devices to be equipped with such IoT technology. Particularly, for efficient operation of IoT devices, high power efficiency is required, so power management is critical. In a mobile communication system, technology called paging has been introduced to transmit data reception notifications to a terminal in an idle or inactive state such that the terminal transitions to a connected state and perform data transmission and reception. When there are no data transmission and reception, the terminal transitions back to an idle or inactive state to remain in a sleep mode. Here, in order to reduce battery consumption, the terminal periodically monitors only a Paging Occasion (PO) according to a Discontinuous Reception (DRX) cycle. However, periodic and frequent monitoring of such POs increases the power consumption of the terminal, so a low-power wake-up signal is required. The 3rd Generation Partnership Project (3GPP) has been conducting various studies on low-power wake-up signals.

Recently, in Rel-15, a method that provides an option not to exit from a power saving state unless a specific signal called a ‘Wake Up Signal (WUS)’ is received has been proposed. This technology is referred to as Low Power WUS (LP-WUS), and it provides ultra-deep sleep that provides a longer power saving time than a deep sleep period, which is the power saving time of a main RF module (Main Radio (MR)). This is a technique that delays the wake-up time for monitoring a Physical Downlink Control Channel (PDCCH) based on scheduling information provided through a Physical Downlink Shared Channel (PDSCH) as much as possible, thereby reducing power consumption. A terminal applying LP-WUS/WUS includes a separate Low Power (LP) receiver for receiving an LP-WUS, in addition to a receiver for an MR. According to the basic principle of the operation, the MR receiver of the terminal enters an ultra-deep sleep mode, and the LP receiver performs only monitoring for receiving an LP-WUS. When an LP-WUS is received, the terminal is awakened, the MR receiver is turned on, and the terminal exits from the Ultra-Deep Sleep (UDS) mode to monitor the PDCCH. For LP-WUS/WUS, there are a duty-cycled mode and a continuous mode, which operate with different mechanisms.

Although LP-WUS/WUS technology needs to transmit a wake-up signal to a terminal that requires data transmission and reception and to enable ultralow-power battery consumption, the wake-up signal is also transmitted to terminals within the same network. Accordingly, unnecessary wake-up signals are transmitted, which may result in consumption of the battery power of the neighboring terminals. In other words, it is required to wake up only specific UEs at specific times, rather than targeting all terminals within the DRX cycle. To this end, when target terminals are divided into subgroups to transmit wake-up signals to only a corresponding group, unnecessary wakeups may be minimized, and the false alarm rate may be reduced as the subgroups are further subdivided.

### SUMMARY OF THE INVENTION

An object of the present disclosure is to provide a subgrouping method and apparatus for ultralow-power consumption of an IoT terminal in a wireless environment, which performs dynamic subgrouping for assigning a terminal to a subgroup defined according to the characteristics of the terminal by defining LP-WUS and PEI subgroups in consideration of factors, such as the traffic pattern, mobility, and average data transmission period (DRX cycle) of the terminal in order to apply efficient subgrouping in a two-level subgrouping method that employs LP-WUS and PEI subgroups.

Another object of the present disclosure is to provide a subgrouping method and apparatus for ultralow-power consumption of an IoT terminal in a wireless environment, which performs a dual subgrouping method that dynamically configures a PEI-based group and an LP-WUS-based group respectively by reflecting the operation pattern of a UE and the time-based network state, in order to maximize reduction of paging false alarm rates based on LP-WUS and PEI.

A wireless communication method performed by a user equipment (UE) according to the present disclosure includes receiving, by the UE, a wake-up signal (WUS) configuration; and monitoring a WUS associated with an ID of an LP-WUS subgroup to which the UE belongs, based on the WUS configuration, and the ID of the LP-WUS subgroup may be determined based on a UE_ID of the UE and a predefined number for power saving for each time period (T).

In the wireless communication method performed by a user equipment (UE), the ID of the LP-WUS subgroup (SubgroupID_{LP-WUS}) is determined based on Equation (1) below:

$$\begin{matrix}{SubgroupID}_{LP - WUS} = ( ⌊ \frac{UE\_ID}{N \cdot {N}_{s} \cdot {K}_{dyn}} ⌋ mod subgroupsNumForUEID\_LP - WUS ) \\ + ( subgroupsNumPerPO\_LP - WUS \\ - subgroupsNumForUEID\_LP - WUS )\end{matrix} \qquad ( 1 )$$

where N denotes the total number of paging frames during T, N_{S} denotes the number of Paging Occasions (POs) for one paging frame, subgroupsNumForUEID_LP-WUS denotes the number of WUS subgroups for UE_ID-based subgrouping in one PO, subgroupsNumPerPO_LP-WUS denotes the total number of available WUS subgroups for one PO, and K_{dyn} is a parameter determined based on the number of UEs within a current cell boundary, the number for power saving, and the number of UEs paged during T.

In the wireless communication method performed by a user equipment (UE), K_{dyn} is determined based on Equation (2) below:

$${K}_{dyn} = ⌈ \frac{C \cdot D}{U} ⌉ \qquad ( 2 )$$

where C denotes the number of UEs within the current cell boundary, D denotes the number for power saving, and U denotes the number of UEs paged during T.

The number of LP-WUS subgroups may be dynamically adjusted for each time period (T). The number of LP-WUS subgroups may be determined based on the number of UEs that are active in a cell during T.

The number of WUS subgroups at a time point T (N_{SG}(T)) may be determined based on Equation (3) below:

$${N}_{SG} ( T ) = ⌈ \frac{{C}_{T} \cdot {W}_{T}}{{U}_{opt}} ⌉ \qquad ( 3 )$$

where Uₒₚₜ denotes a predefined optimal number of UEs per subgroup, C_{T} denotes the number of UEs that are active in the cell measured at the time point T, and W_{T} denotes a preset power optimization weight for each time point (T).

The ID of the LP-WUS subgroup (SubgroupID_{LP-WUS}) may be determined based on Equation (4) below:

SubgroupID_{LP-WUS}=(Hash(UE_ID+T+D_{T})mod N_{SG}(T)) (4)

where D_{T} denotes a predefined number for power saving at the time point T, Hash( ) is a hash function, and any of various known hash functions may be used.

A Physical-layer Early Indication (PEI) subgroup to which the UE belongs may be dynamically determined. The PEI subgroup may be determined independently of the LP-WUS subgroup.

The PEI subgroup may be dynamically determined for each time period based on at least one of a historical traffic frequency, a DRX cycle and an RRC state history, a mobility pattern of the UE, a service type, a QoS profile, a paging frequency, a wake-up log, UE location stability, capability information of the UE, or time-period-based traffic characteristics, or a combination thereof.

A wireless communication method performed by a base station according to the present disclosure includes transmitting a wake-up signal (WUS) configuration to a user equipment (UE) and transmitting, based on the WUS configuration, a WUS associated with an ID of an LP-WUS subgroup to which the UE belongs, and the ID of the LP-WUS subgroup may be determined based on a UE_ID of the UE and a predefined number for power saving for each time period (T).

The ID of the LP-WUS subgroup (SubgroupID_{LP-WUS}) may be determined based on Equation (1) described above.

The number of LP-WUS subgroups may be dynamically adjusted for each time period (T). The number of LP-WUS subgroups may be determined based on the number of UEs that are active in a cell during T.

The number of WUS subgroups at a time point T (N_{SG}(T)) may be determined based on Equation (3) described above.

The ID of the LP-WUS subgroup (SubgroupID_{LP-WUS}) may be determined based on Equation (4) described above.

A Physical-layer Early Indication (PEI) subgroup to which the UE belongs may be dynamically determined.

The PEI subgroup may be determined independently of the LP-WUS subgroup.

The PEI subgroup may be dynamically determined for each time period based on at least one of a historical traffic frequency, a DRX cycle and an RRC state history, a mobility pattern of the UE, a service type, a QoS profile, a paging frequency, a wake-up log, UE location stability, capability information of the UE, or time-period-based traffic characteristics, or a combination thereof.

A user equipment for wireless communication according to the present disclosure includes an MR receiver for receiving a wake-up signal (WUS) configuration from a base station, a Low Power (LP) receiver for receiving a WUS from the base station, and a control unit for monitoring a WUS associated with an ID of a WUS subgroup to which the user equipment (UE) belongs, based on the WUS configuration, and the ID of the WUS subgroup may be determined based on a UE_ID of the UE and a predefined number for power saving for each time period (T).

A base station for wireless communication according to the present disclosure includes a communication unit for transmitting a wake-up signal (WUS) configuration to a user equipment (UE) and a control unit for controlling transmission of a WUS associated with an ID of an LP-WUS subgroup to which the UE belongs, based on the WUS configuration, and the ID of the LP-WUS subgroup may be determined based on a UE_ID of the UE and a predefined number for power saving for each time period (T).

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view for explaining a two-level static subgrouping method;

FIG. 2 is a view for explaining a phased dynamic subgrouping method according to the present disclosure;

FIG. 3 is a block diagram illustrating the configuration of a communication system for ultralow-power consumption of an IoT terminal in a wireless environment according to the present disclosure;

FIG. 4 is a flowchart illustrating the process of a wireless communication method performed by a UE in order to implement a subgrouping method for ultralow-power consumption of an IoT terminal in a wireless environment according to an embodiment of the present disclosure;

FIG. 5 is a flowchart illustrating the process of a wireless communication method performed by a base station in order to implement a subgrouping method for ultralow-power consumption of an IoT terminal in a wireless environment according to an embodiment of the present disclosure; and

FIG. 6 is a view illustrating the configuration of a computer system according to an embodiment of the present disclosure.

### DESCRIPTION OF THE PREFERRED EMBODIMENTS

Because the present disclosure may be variously changed and may have various embodiments, specific embodiments will be described in detail below with reference to the attached drawings. However, it should be understood that those embodiments are not intended to limit the present disclosure to specific disclosure forms and that they include all changes, equivalents or modifications included in the spirit and scope of the present disclosure.

Specific embodiments will be described in detail below with reference to the attached drawings. These embodiments are described in sufficient detail to enable those skilled in the art to practice the embodiments. It should be understood that the embodiments differ from each other, but the embodiments do not need to be exclusive of each other. For example, a particular feature, structure, or characteristic described herein in connection with one embodiment may be implemented in another embodiment without departing from the spirit or scope of the present disclosure. Also, it should be understood that the location or arrangement of individual elements in the disclosed embodiments may be changed without departing from the spirit or scope of the embodiments. Therefore, the following detailed description is not to be taken in a limiting sense, and if appropriately interpreted, the scope of the exemplary embodiments is limited only by the appended claims, along with the full range of equivalents to which the claims are entitled.

In the drawings, similar reference numerals are used to designate the same or similar functions in various aspects. The shapes, sizes, etc. of components in the drawings may be exaggerated to make the description clearer. Also, the terms “and/or” may include combinations of a plurality of related described items or any of a plurality of related described items. The terms “part,” “unit,” and “module” as used herein may include one or more components, and may include software components and/or hardware components.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure. Similarly, a second element could also be referred to as a first element.

It will be understood that when a component is referred to as being “connected” or “coupled” to another component, the two components may be directly connected or coupled to each other, or intervening components may be present between the two components. It will be understood that when a component is referred to as being “directly connected or coupled” to another component, no intervening components are present between the two components.

Components in the embodiments of the present disclosure are independently shown in order to indicate different characteristic functions, but this does not mean that each of the components is formed of a separate piece of hardware or software. That is, components are arranged and included for convenience of description, and at least two of the components may form one component, or one component may be divided into multiple components to perform respective functions. An embodiment into which the components are integrated or an embodiment from which some components are separated is included in the scope of the present disclosure, as long as it does not depart from the essence of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added. That is, in the embodiments, an expression describing that a component “comprises” a specific component means that additional components may be included within the scope of the practice of the present disclosure or the technical spirit of the present disclosure, but does not preclude the presence of components other than the specific component.

In the embodiments, the term “at least one” may mean one of one or more numbers, such as 1, 2, 3, and 4. In the embodiments, the term “a plurality of” may mean one of two or more numbers, such as 2, 3 and 4.

At least portion of the parts, units, and modules described in the embodiments may be program modules and may communicate with external devices or systems.

The program modules may include a routine, a subroutine, a program, an object, a program component, a data structure, and the like for performing functions or operations according to an embodiment or for implementing abstract data types according to an embodiment, but they are not limited thereto.

Some components of embodiments are not essential components for performing essential functions, but may be optional components for improving only performance. The embodiments may be implemented by including only essential components for implementing the essence of the embodiments, excluding components used only to improve performance. For example, a structure including only essential components, excluding optional components used only to improve performance, is also included in the scope of the embodiments.

Hereinafter, embodiments will be described in detail below with reference to the accompanying drawings so that those having ordinary knowledge in the technical field can easily practice the embodiments. In the following description of the embodiments, detailed descriptions of known functions or configurations which are deemed to obscure the gist of the present specification will be omitted. Further, the same reference numerals are used to designate the same components throughout the drawings, and repeated descriptions of the same components will be omitted.

In recent 3GPP studies, a method for reducing a paging false alarm rate has been proposed by suggesting a method of jointly using subgrouping schemes of LP-WUS and Physical-layer Early Indication (PEI). In this method, terminals are awakened first through the LP-WUS subgrouping scheme, and the final paging of the terminals that are awakened in the first stage is then determined through the PEI subgrouping scheme. If the two-level subgrouping is performed through the two subgrouping schemes, only the terminals for which paging is actually required monitor the paging, and it is possible to more efficiently transmit and receive wake-up signals. In the 3GPP standard, the UE_ID-based subgrouping equation defined in the document TS 38.304 is applied to LP-WUS in order to formulate this mechanism, and a K value is applied such that LP-WUS and PEI operate independently of each other. The equation is as shown in Equation (1) below:

$$\begin{matrix}{SubgroupID}_{LP - WUS} = ( ⌊ \frac{UE\_ID}{N \cdot {N}_{s} \cdot K} ⌋ mod subgroupsNumForUEID\_LP - WUS ) \\ + ( subgroupsNumPerPO\_LP - WUS \\ - subgroupsNumForUEID\_LP - WUS )\end{matrix} \qquad ( 1 )$$

N denotes the total number of paging frames (PFs) in the DRX cycle, N_{S} denotes the number of paging occasions (POs) for each paging frame (PF), and K is a coefficient for preventing interference between LP-WUS and PEI subgroups and is defined as a fixed value, which may be set to a number equal to or greater than 8.

SubgroupID_{LP-WUS} is a unique ID of the subgroup to which the terminal receiving an LP-WUS belongs, and is an identifier for efficiently distributing and managing wake-up signal reception resources.

SubgroupsNumForUEID_LP-WUS is a parameter that indicates the number of subgroups divided based on UE_ID for LP-WUS. SubgroupsNumForUEID_LP-WUS is the total number of subgroups divided based on UE_ID (the identifier of the terminal) in order to distinguish the user terminals (user equipment (UE)) that receive LP-WUS signals. SubgroupsNumForUEID_LP-WUS is the total number of terminal subgroups for LP-WUS and is a parameter for supporting resource distribution and power saving by dividing terminals based on UE_ID.

SubgroupsNumPerPO_LP-WUS indicates the total number of LP-WUS subgroups allowed for one Paging Occasion (PO), that is, per paging monitoring time. SubgroupsNumPerPO_LP-WUS is the maximum number of LP-WUS subgroups that can be simultaneously managed in one Paging Occasion (PO) and is a limited value for wake-up signal resource distribution and efficiency.

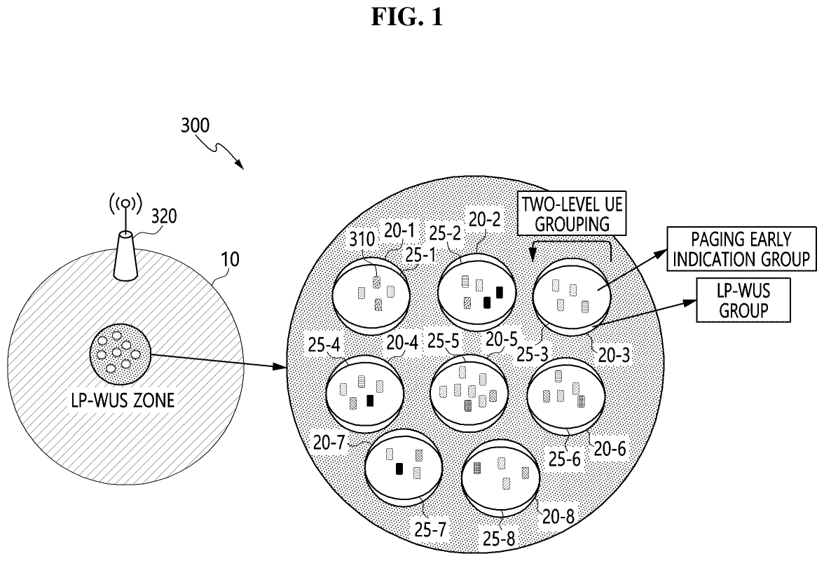

FIG. 1 is a view for explaining a two-level static subgrouping method. FIG. 1 represents the technique proposed in the present contribution based on the above description.

Referring to FIG. 1, the LP-WUS zone that can be configured in a single cell 10 is currently set to have eight subgroups 20-1 to 20-8 in the standard, and the eight subgroups are groups under the same conditions. Terminals 310, each having different conditions (represented by different hatchings), are assigned to one of the eight subgroups 20-1 to 20-8. The different conditions of terminals indicate different conditions related to LP-WUS and PEI, and in the present disclosure, these conditions are not formalized or limited, that is, all terminals under any conditions may be included. In the current standard, methods such as a round-robin method or assignment based on the DRX cycle are applied as the method of assigning terminals to subgroups. However, these methods do not take into account the individual characteristics of terminals and therefore have many problems.

As described above, the two-level subgrouping method that applies the LP-WUS subgroups 20-1 to 20-8 and the PEI subgroups 25-1 to 25-8 is an efficient method for reducing the paging false alarm rate of terminals, but when a large number of devices are concentrated in the LP-WUS zone, if an appropriate subgrouping scheme is not applied, multiple terminals may be concentrated in a single subgroup. Also, if subgrouping is performed without considering the characteristics of each terminal, unnecessary wake-up of terminals may occur, or terminals that actually require paging may experience delayed wake-up. These may be caused by assigning UEs to subgroups without considering various factors, such as mobility or traffic transmission/reception characteristics of the UEs.

### 1. Dynamic Subgrouping Formula

In the above-described UE_ID-based subgrouping scheme, a fixed coefficient, K, is applied in order to prevent interference between LP-WUS and PEI subgroups, thereby preventing group overlap. However, the fixed K value cannot reflect diverse network environments and dynamic UE traffic distributions, and problems such as deterioration of subgrouping efficiency or an increasing paging false alarm rate may be caused depending on the situation. In particular, when the number of UEs within a cell changes or when the traffic density varies according to the time of a day, an excessively large fixed K value may cause overly subdivided subgroups, and paging resources may be wasted. Conversely, if the K value is small, overlap between the LP-WUS and PEI subgroups may increase the possibility of false wake-up. Therefore, a formula capable of dynamically adjusting the K value by reflecting the real-time network state (e.g., the number of UEs, traffic load, a paging frequency, etc.) is required. The present disclosure proposes dynamic K and optimizes the distribution of LP-WUS and PEI subgroups depending on the situation by performing calculation using K, thereby providing a method capable of maximizing power saving of a UE while maintaining paging efficiency. Equation (2) below applies dynamic K.

$$\begin{matrix}{SubgroupID}_{LP - WUS} = ( ⌊ \frac{UE\_ID}{N \cdot {N}_{s} \cdot {K}_{dyn}} ⌋ mod subgroupsNumForUEID\_LP - WUS ) \\ + ( subgroupsNumPerPO\_LP - WUS \\ - subgroupsNumForUEID\_LP - WUS )\end{matrix} \qquad ( 2 )$$

Here, K_{dyn} is a parameter corresponding to dynamic K, and may be determined based on Equation (3) below:

$${K}_{dyn} = ⌈ \frac{C \cdot D}{U} ⌉ \qquad ( 3 )$$

Here, C denotes the number of UEs within the current cell boundary, D denotes a number for power saving for each time period, and U denotes the number of UEs paged for a certain time period.

### 2. Dynamic Subgrouping Method

In mobile communication systems, various low-power paging techniques for maximizing the power efficiency of user terminals (IoT devices) are introduced, and in particular, research on a dual paging procedure that combines Low Power Wake-Up Signal (LP-WUS) and Physical-layer Early Indication (PEI) is being conducted in the 3GPP standard in order to reduce the false alarm rate of UEs and unnecessary RF activation in the Discontinuous Reception (DRX)-based paging structure. However, because the proposed subgrouping scheme is mainly based on a static structure and does not sufficiently reflect the network load variation over time or operational characteristics of each UE, there are limitations in power saving and reducing the false alarm rate. For example, a fixed subgroup interval or a non-dynamic K coefficient may lead to reduced paging efficiency or interference between subgroups depending on changes in the actual network environment. Accordingly, the present disclosure proposes a dynamic dual subgrouping scheme that simultaneously reflects the behavior pattern of a UE and network load conditions changing over time, and in the proposed scheme, a time-based LP-WUS subgroup and a behavior-based PEI group are independently configured, and the size and distribution of each subgroups are adjusted depending on the situation, whereby a method capable of significantly reducing the paging false alarm rate and minimizing the power consumption of the UE is provided.

### 2-1. PEI Subgroup Configuration Method Based on User Characteristics

In order to minimize the power consumption of user equipment (UE) and improve paging efficiency in a wireless communication system, the present disclosure proposes a method of dynamically assigning subgroups according to the operation and service characteristics of each UE when a Physical-layer Early Indication (PEI)-based subgroup is configured. The network dynamically determines the PEI subgroup to which each UE belongs by comprehensively considering the following various factors.
historical traffic frequency: the number of UL/DL traffic occurrences or an average data volume within a certain period
DRX cycle and RRC status history: periodic activity patterns of the UE
UE's mobility pattern: frequency of inter-cell movement, cell residence time, and a handover history
service type or QoS profile: responsiveness requirements of the service used by UE, such as URLLC, mMTC, eMBB, etc.
recent paging events and RF activation history: a paging frequency and a wake-up log
UE location stability: duration of stay within the same cell or TA
Terminal capacity information of UE: LP-WUS reception sensitivity, a battery state, dual-reception capability, etc.
time-dependent traffic characteristics: information about a specific time period during which the activity of UE is concentrated

Based on such h information, UEs expected to have high-frequency data transmission/reception or UEs using a service type requiring real-time responses are included exclusively or in a small number of PEI group to enable fast paging responses, but UEs that remain in an inactive state for an extended period or have a low traffic frequency are assigned to a subgroup containing multiple UEs to prioritize power saving. Such a multi-dimensional terminal classification method may better reflect realistic network operating environments compared to fixed UE_ID-based grouping, and may effectively reduce overall system power consumption by minimizing the number of UEs that need to actually activate the main RF after receiving PEI. Also, the PEI subgroup configuration may be readjusted in real time depending on the dynamically changed UE behavior pattern or service requirements, whereby high adaptability and flexibility may be provided.

### 2-2. LP-WUS Subgroup Configuration Method Based on Traffic Characteristics

The LP-WUS subgrouping method based on traffic characteristics analyzes traffic characteristics and patterns to vary the LP-WUS subgroup configuration and terminal assignment methods based on the load status in a cell. The first method increases the number of LP-WUS subgroups (up to a maximum of 8) when the traffic load is low and power efficiency maximization is required, thereby increasing the number of terminals transitioning to a ultra-deep-sleep mode. However, when the traffic load is high and low latency is required, the method decreases the number of LP-WUS subgroups, thereby increasing efficiency for paging resources.

The second method proposes a method for assigning terminals to subgroups. When densely located terminals are concentrated in a specific subgroup, it is difficult to have the effect of reducing the false alarm rate, or network performance degradation may be caused. To solve these problems, LP-WUS subgroups are defined for each time period and are designed to be variably controlled by reflecting the density of terminals connected to a cell (considering the traffic load level) in real time such that specific terminals are evenly distributed, rather than being concentrated in a specific subgroup. Accordingly, the method intends to reduce the false alarm rate and the power consumption of terminals by uniformly maintaining the number of terminals in each subgroup and preventing terminals from being congested in a specific group. The network defines a specific time period T and measures the number of terminals (C_{T}) that are active in a cell at a specific time point during the time period T. Also, the number of subgroups N_{SG}(T) is dynamically set in consideration of a power optimization weight W_{T} for each time period T. Equation (4) below represents the corresponding formula.

$${N}_{SG} ( T ) = ⌈ \frac{{C}_{T} \cdot {W}_{T}}{{U}_{opt}} ⌉ \qquad ( 4 )$$

Uₒₚₜ defines the optimal number of terminals in each subgroup, whereby N_{SG}(T) is dynamically calculated.

In order to distribute terminals based on this equation, the density during a specific time period T is reflected, and the final equation for assigning subgroups is defined as shown in Equation (5) below:

SubgroupID_{LP-WUS}=(Hash(UE_ID+T+D_{T})mod N_{SG}(T)) (5)

When subgrouping is performed by considering the density of terminals in an active state within a cell during a time period T, as shown in the above equation, load balancing between subgroups may be provided, and terminals may be distributed, rather than being concentrated in a specific subgroup, in a specific time period. Therefore, the false alarm rate may be minimized, which may have the effect of reducing power.

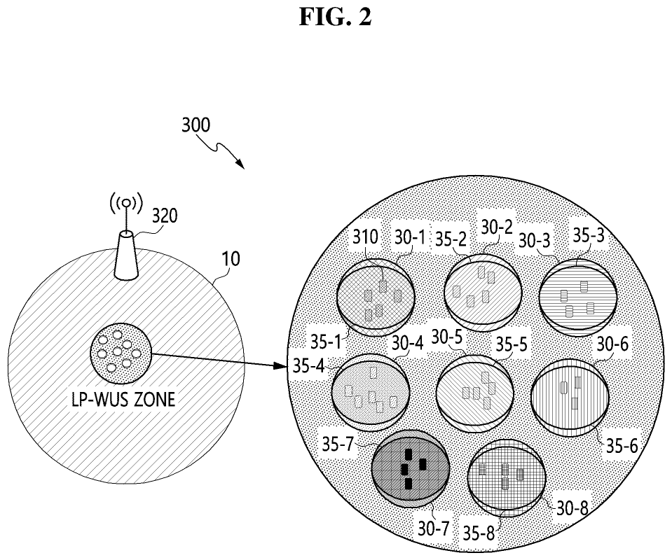

FIG. 2 is a view for explaining a phased dynamic subgrouping method according to the present disclosure. FIG. 2 shows that terminals are assigned to one of eight subgroups in a single LP-WUS zone when the method proposed in the present disclosure is applied.

Referring to FIG. 2, the respective terminals 310 have various characteristics (represented by different hatchings), and eight LP-WUS subgroups 30-1 to 30-8 and eight PEI subgroups 35-1 to 35-8 are configured based on eight different conditions (various characteristics being represented by different hatchings) by considering the characteristics of the terminals 310. It shows that, when a terminal enters the LP-WUS zone, the terminal is assigned to the most suitable LP-WUS subgroup and PEI subgroup by considering the characteristics of the terminal (the terminal is assigned to the subgroup represented by a similar hatching). When this method is applied, a problem in which terminals are densely concentrated in a single subgroup may be solved. Also, because LP-WUS and PEI methods considering the characteristics of terminals are applied, battery consumption resulting from malfunction due to unnecessary alarms may be reduced, and it is expected to increase the overall network efficiency.

FIG. 2 is provided merely to facilitate understanding of the idea, but it does not limit the scope of the present disclosure. It is limited to illustrating the result of the method of assigning each terminal to an optimal subgroup.

Table 1 below (differentiation of core technology) shows the distinctions between existing technology and the technology proposed by the present disclosure. In the existing technology, the method of assigning subgroups of LP-WUS and PEI based on a fixed k value causes deterioration of network efficiency, and because the characteristics of terminals are not considered, which results in problems such as an increased false alarm rate, increased battery consumption, and the like. In contrast, the proposed technology assigns subgroups of LP-WUS and PEI based on the characteristics of terminals, thereby mitigating subgroup congestion, reducing the false alarm rate and battery consumption, and improving network efficiency.

TABLE 1

| | existing | |
|---|---|---|
| items | technology | present disclosure |
| K value | fixed | dynamic (based on network state) |
| grouping criteria | UE ID | UE characteristics (behavior, |
| | | traffic, time, etc.) |
| flexibility | low | very high |
| power efficiency | middle | very high |
| false alarm rate | high | low |

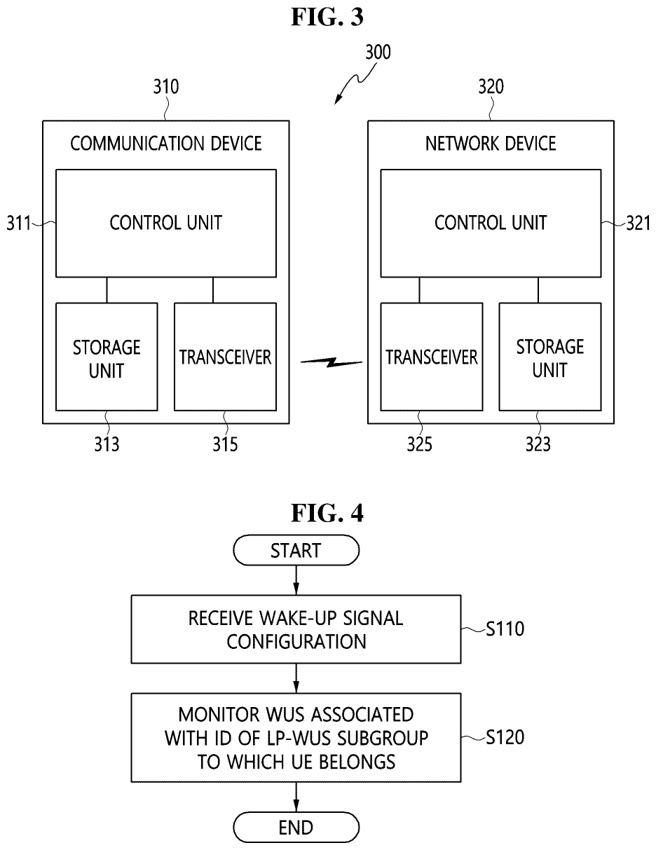

FIG. 3 is a block diagram illustrating the configuration of a communication system for ultralow-power consumption of an IoT terminal in a wireless environment according to the present disclosure.

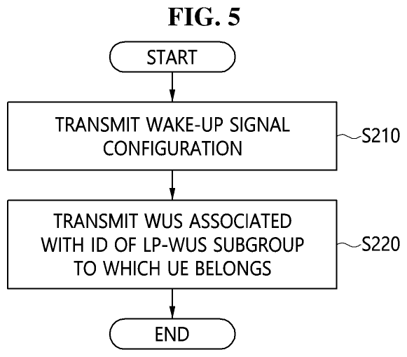

Referring to FIG. 3, the communication system 300 according to the present disclosure may include at least one communication device 310 and a network device 320. The communication device 310 and the network device 320 may perform various functions in order to implement the schemes, techniques, processes, and methods described in the present disclosure with respect to LP-WUS transmission in mobile communication, and this relates to the various design, concepts, schemes, and methods proposed above, the scenarios/schemes described for user devices and network devices of mobile communication, and the method described with reference to FIGS. 4 and 5.

The communication device 310 may be part of an electronic device, and the electronic device may be a portable or mobile device, a wearable device, a wireless communication device, or a computing device such as a UE. For example, the communication device 310 may be implemented in a smartphone, a smartwatch, a personal digital assistant, a digital camera, or computing equipment such as a tablet computer, a laptop computer, or a notebook computer. The communication device 310 may also be part of a machine-type device, and it may be an IoT, NB-IoT, or IIoT device and a fixed or stationary device, a home appliance, a wired communication device, or a computing device. For example, the communication device 310 may be implemented in a smart thermostat, a smart refrigerator, a smart door lock, a wireless speaker, or a home control center. Alternatively, the communication device 310 may be implemented in the form of one or more Integrated Circuit (IC) chips, and may be, for example, one or more single-core processors, one or more multi-core processors, one or more reduced instruction set computing (RISC) processors, or one or more complex instruction set computing (CISC) processors, without limitation. The communication device 310 may include at least part of the components (e.g., a control unit 311) illustrated in FIG. 3. Also, the communication device 310 may further include one or more other components (e.g., an internal power supply device, a display device, and/or a user interface device) that are unrelated to the proposed scheme of the present disclosure, and such components are not illustrated in FIG. 3 for simplicity and conciseness and will not be described below.

The network device 320 may be part of a network apparatus, and the network apparatus may be a network node, such as a satellite, a base station, a small cell, a router, or a gateway. For example, the network device 320 may be implemented in an eNodeB of an LTE network, a gNB of a 5G/NR, IoT, NB-IoT, or IIoT network, or a satellite or base station of a 6G network. Alternatively, the network device 320 may be implemented in the form of one or more IC chips, and may be, for example, one or more single-core processors, one or more multi-core processors, or one or more RISC or CISC processors, without limitation. The network device 320 may include at least part of the components (e.g., a control unit 321) illustrated in FIG. 3. Also, the network device 320 may further include one or more other components (e.g., an internal power supply device, a display device, and/or a user interface device) that are unrelated to the proposed scheme of the present disclosure, and such components are not illustrated in FIG. 3 for simplicity and conciseness and will not be described below.

In some embodiments, each of the control unit 311 and the control unit 321 may be implemented in the form of one or more single-core processors, one or more multi-core processors, or one or more CISC processors. In another aspect, each of the control unit 311 and the control unit 321 may be configured and disposed to achieve a specific purpose by including an electronic component in the form of hardware (and optionally firmware) (e.g., one or more transistors, one or more diodes, one or more capacitors, one or more resistors, one or more inductors, one or more memristors, and/or one or more varactors without limitation). In other words, in at least some implementations, each of the control unit 311 and the control unit 321 may be a special-purpose machine that is specifically designed, disposed, and configured to perform autonomous reliability enhancement in a device (e.g., the communication device 310) and a network (e.g., the network device 320) according to various implementations of the present disclosure.

In some embodiments, the communication device 310 may include a transceiver 315 that is connected to the control unit 311 and is capable of wirelessly transmitting and receiving data. In some implementations, the transceiver 35 may include a main transceiver (e.g., the above-described MR receiver) or an LP-WUS transceiver (e.g., the above-described LP receiver). In some implementations, the communication device 310 may further include a storage unit 313 capable of storing data therein and connected to the control unit 311 to enable access by the control unit 311.

In some embodiments, the network device 320 may also include a transceiver 325 that is connected to the control unit 321 and is capable of wirelessly transmitting and receiving data. In some implementations, the network device 320 may also further include a storage unit 323 capable of being accessed by the control unit 321 and capable of storing data therein. Accordingly, the communication device 310 and the network device 320 may wirelessly communicate with each other through the respective transceivers 315 and 325. In order to facilitate better understanding, the following description of the operations, functions, and capabilities of the communication device 310 and the network device 320 is provided based on a mobile communication environment in which the communication device 310 is implemented as a communication device or a UE and the network device 320 is implemented as a network node or base station of a communication network.

In some embodiments, the control unit 311 may receive a WUS configuration from the base station 320 through the transceiver 315. The control unit 311 may monitor a wake-up signal based on the WUS configuration. In some implementations, the wake-up signal may be associated with at least one of a UE group ID, an LP-WUS subgroup ID, cell information, time information, or SFN information, or a combination thereof.

In some implementations, the control unit 311 may perform synchronization through the LP-WUS transceiver of the transceiver 315 when the main transceiver of the transceiver 315 is in a power-saving mode. In some implementations, the control unit 311 may perform synchronization based on an SSB or PBCH block through the LP-WUS transceiver of the transceiver 315. In some implementations, the control unit 311 may perform synchronization based on an LP-SS through the LP-WUS of the transceiver 315. In some implementations, the LP-SS period may include at least one of 320 ms, 640 ms, 1280 ms, 2560 ms, 5120 ms, or 10240 ms, or a combination thereof. In some implementations, the LP-SS may include an LP-WUS preamble.

In some implementations, the control unit 311 may determine whether the communication device 310 is in the same cell. The control unit 311 may determine whether to wake up the main transceiver of the transceiver 315 depending on whether the communication device 310 is in the same cell and depending on the wake-up signal.

In some implementations, the control unit 321 may transmit the WUS configuration to the communication device 310 through the transceiver 325. Based on the WUS configuration, the control unit 321 may transmit a wake-up signal to the communication device 310 through the transceiver 325.

FIG. 4 is a flowchart illustrating the process of a wireless communication method performed by a UE in order to implement a subgrouping method for ultralow-power consumption of an IoT terminal in a wireless environment according to an embodiment of the present disclosure.

Referring to FIG. 4, the UE 310 receives a wake-up signal (WUS) configuration at step S110.

Based on the WUS configuration, the UE 310 monitors a WUS related to the ID of the LP-WUS subgroup to which the UE belongs at step S120. Here, the ID of the LP-WUS subgroup to which the UE 310 belongs may be determined based on the UE_ID of the UE 310 and a predefined number for power saving for each time period T. In some embodiments, the ID of the LP-WUS subgroup to which the UE 310 belongs may be determined based on Equation (2) described above.

The number of LP-WUS subgroups may be dynamically adjusted for each time period T. In some embodiments, the number of LP-WUS subgroups may be dynamically determined for each time period T based on the number of UEs that are active within a cell during T. The number of WUS subgroups at a time point T may be determined based on Equation (4) described above.

In some embodiments, the ID of the LP-WUS subgroup to which the UE 310 belongs may be determined based on Equation (5) described above.

The PEI subgroup to which the UE 310 belongs and the LP-WUS subgroup to which the UE 310 belongs may be independently determined. The PEI subgroup to which the UE 310 belongs may be dynamically determined. The PEI subgroup to which the UE 310 belongs may be dynamically determined for each time period based on at least one of a historical traffic frequency, a DRX cycle and an RRC state history, the mobility pattern of the UE, a service type, a QoS profile, a paging frequency, a wake-up log, UE location stability, the capability information of the UE, or time-period-based traffic characteristics, or a combination thereof.

FIG. 5 is a flowchart illustrating the process of a wireless communication method performed by a base station in order to implement a subgrouping method for ultralow-power consumption of an IoT terminal in a wireless environment according to an embodiment of the present disclosure.

Referring to FIG. 5, the base station 320 transmits a wake-up signal (WUS) configuration to the UE 310 at step S210. The base station 320 may receive the WUS configuration from a Core Network (CN). In some embodiments, a Mobility Management Entity (MME) may generate the WUS configuration and transmit the generated WUS configuration to the base station 320. Here, the generated WUS configuration may include information associated with the ID of the LP-WUS subgroup to which the UE 310 belongs. In some implementations, the information associated with the ID of the LP-WUS subgroup to which the UE 310 belongs may include at least one of information indicating the ID of the LP-WUS subgroup, information about the method of determining the LP-WUS subgroup, or information for calculating the ID of the LP-WUS subgroup, or a combination thereof.

At step S210, the base station 320 may transmit System Information (SI) including the wake-up signal (WUS) configuration to the UE 310.

Based on the WUS configuration, the base station 320 transmits a WUS associated with the ID of the LP-WUS subgroup to which the UE 310 belongs at step S220. Here, the ID of the LP-WUS subgroup to which the UE 310 belongs may be determined based on the UE_ID of the UE 310 and a predefined number for power saving for each time period T. In some embodiments, the ID of the LP-WUS subgroup to which the UE 310 belongs may be determined based on Equation (2) described above.

The number of LP-WUS subgroups may be dynamically adjusted for each time period T. In some embodiments, the number of LP-WUS subgroups may be dynamically determined for each time period T based on the number of UEs that are active within a cell during T. The number of WUS subgroups at a time point T may be determined based on Equation (4) described above.

In some embodiments, the ID of the LP-WUS subgroup to which the UE 310 belongs may be determined based on Equation (5) described above.

The PEI subgroup to which the UE 310 belongs and the LP-WUS subgroup to which the UE 310 belongs may be independently determined. The PEI subgroup to which the UE 310 belongs may be dynamically determined. The PEI subgroup to which the UE 310 belongs may be dynamically determined for each time period based on at least one of a historical traffic frequency, a DRX cycle and an RRC state history, the mobility pattern of the UE, a service type, a QoS profile, a paging frequency, a wake-up log, UE location stability, the capability information of the UE, or time-period-based traffic characteristics, or a combination thereof.

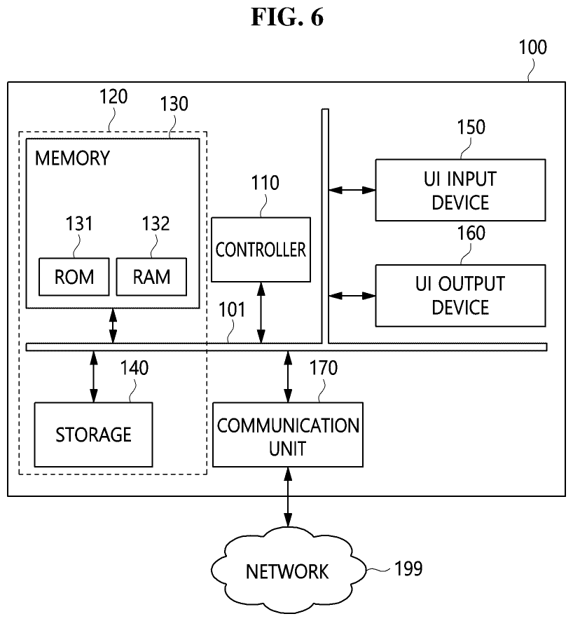

FIG. 6 is a view illustrating the configuration of a computer system according to an embodiment of the present disclosure.

Referring to FIG. 6, the communication device 310 may be implemented as a computer system 100. The computer system 100 may include a bus 101, a controller 110, storage 120, a user interface (UI) input device 150, a UI output device 160, and a communication unit 170. The storage 120 may include at least one of memory 130, or storage 140, or a combination thereof. The controller 110, the memory 130, the storage 140, the UI input device 150, the UI output device 160, and the communication unit 170 may communicate with each other via the bus 101.

When the communication device 310 is implemented as the computer system 100, the controller 110 may include the control unit 311, the communication unit 170 may include the transceiver 315, and the storage 120 may include the storage unit 313.

The controller 110 may be a semiconductor device for executing processing instructions stored in the storage 120. The controller 110 may be at least one hardware processor. The controller 110 may be configured with one or more cores and may include processors for data analysis and deep learning, such as a Central Processing Unit (CPU), a Graphics Processing Unit (GPU), a Digital Signal Processor (DSP), an Application-Specific Integrated Circuit (ASIC), a General-Purpose Graphics Processing Unit (GPGPU), a Tensor Processing Unit (TPU), and the like.

The controller 110 may read a computer program stored in the storage 120 and perform data processing for training a deep-learning network according to an embodiment of the present disclosure.

Program modules may be configured with instructions or code executed by at least one processor of the controller 110. The program modules may be included in the computer system 100 in the form of operating systems, application modules, and other program modules. The program modules may be physically stored on various known memory devices. Also, at least part of the program modules may be stored in a remote memory device that can communicate with the communication unit 170.

The controller 110 may execute instructions or code of the parts, units, and modules described in the embodiments.

The storage 140 may be storage media including at least one of a nonvolatile medium, a detachable medium, a non-detachable medium, a communication medium, or an information delivery medium, or a combination thereof.

The memory 130 may include ROM 131 or RAM 132.

The communication unit 170 may transmit and receive data to and from other network entities over a network 199. Here, the network 199 may be a broadcast network, a private network, or an Internet network, and may include a wired network or a wireless network. The network 199 may indicate one or more portions of a network that may be an ad-hoc network, an intranet, an extranet, Bluetooth, ZigBee, a Virtual Private Network (VPN), a Local Area Network (LAN), a Wireless LAN (IEEE 802.11b, IEEE 802.11a, IEEE802.11g, IEEE802.11n), a Wireless Broadband (WiBro), a Wide Area Network (WAN), a wireless WAN (WWAN), a Metropolitan Area Network (MAN), the Internet, a portion of the Internet, a portion of a Public Switched Telephone Network (PSTN), a Plain Old Telephone Service (POTS) network, a cellular telephone network, a wireless network, a Wi-Fi® network, another type of network, or a combination of two or more of these networks, and may indicate one or more portions of a network connected to another type of network. For example, the network or a portion thereof may include a wireless or cellular network, and the connection may be a Code Division Multiple Access (CDMA) connection, a Global System for Mobile Communications (GSM) connection, or another type of cellular or wireless connection. In such an example, the connection may be implemented by any of various types of data transmission technologies, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standards, others technologies defined by various standard establishing organizations, other long-distance protocols, or other data transmission technologies.

In the above-described embodiments, it may be construed that, when specified processing is applied to a specified target, specified conditions may be required. Also, it may be construed that, when a description is made such that the specified processing is performed under a specified decision, whether the specified conditions are satisfied may be determined based on a specified coding parameter and that, alternatively, when a description is made such that a specified decision is made based on a specified coding parameter, the specified coding parameter may be replaced with an additional coding parameter. In other words, it may be considered that a coding parameter that influences the specified condition or the specified decision is merely exemplary, and it may be understood that, in addition to the specified coding parameter, a combination of one or more other coding parameters may function as the specified coding parameter.

In the above-described embodiments, although the methods have been described based on flowcharts as a series of steps or units, the present disclosure is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the disclosure.

The above-described embodiments include various aspects of examples. Although not all possible combinations for indicating various aspects can be described, those skilled in the art will recognize that additional combinations other than the explicitly described combinations are possible. Therefore, it may be appreciated that the present disclosure includes all other replacements, changes, and modifications belonging to the accompanying claims.

The above-described embodiments according to the present disclosure may be implemented as program instructions that can be executed by various computer components and may be recorded on a computer-readable storage medium. The computer-readable storage medium may include program instructions, data files, and data structures, either solely or in combination. Program instructions recorded on the computer-readable storage medium may have been specially designed and configured for the present disclosure, or may be known to or available to those who have ordinary knowledge in the field of computer software.

The computer-readable storage medium may include information used in embodiments according to the present disclosure. For example, the computer-readable storage medium may include a bitstream, which may include information described in the embodiments according to the present disclosure.

The bitstream may include computer-executable code and/or a program. The computer-executable code and/or program may include pieces of information described in the embodiments and syntax elements described in the embodiments. That is, the pieces of information and syntax elements described in the embodiments may be regarded as computer-executable code within the bitstream, and may be regarded as at least part of the computer-executable code and/or program represented as a bitstream.

The computer-readable storage medium may include a non-transitory computer-readable medium.

Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present disclosure, and vice versa.

The present disclosure relates to subgrouping technology for minimizing power consumption of user equipment (including IoT devices) and effectively reducing a paging false alarm rate in a wireless communication system, and particularly, it provides the effect of overcoming the limitations of existing technology by applying a subgrouping method that dynamically reflects time-based and behavior-based information in a dual paging structure based on LP-WUS and PEI. The present disclosure flexibly adjusts the number of LP-WUS subgroups based on the traffic load for each time period and terminal density in a cell and prevents terminals from being concentrated in a specific subgroup through the hash-based ID distribution technique of the terminal, thereby significantly decreasing the possibility of false wake-up caused by paging. This enables load balancing between terminals within the subgroup, thereby minimizing the number of terminals that wake up after receiving LP-WUS and effectively reducing power consumption during a DRX cycle.

Also, the present disclosure configures a PEI subgroup by considering various behavioral characteristics of a terminal, such as a historical traffic frequency, a DRX cycle, mobility, QoS sensitivity, a paging history, location stability, terminal capability, etc., thereby minimizing the number of terminals that need to activate a main RF. The present disclosure places high-frequency traffic terminals in a small group and places inactive terminals in a large group, thereby preventing the waste of paging resources at the entire network level.

In order to prevent interference between LP-WUS and PEI subgroups, not a fixed value but a K-coefficient, which is dynamically calculated depending on the real-time state of a network (the number of terminals, traffic load, a time period, etc.), is applied to a subgrouping formula. Accordingly, overlap between groups may be minimized, and flexible group management may be enabled. Finally, in order to minimize power loss caused by ping-pong switching phenomena or excessive subgroup reconfiguration, the conditions required for subgroup allocation and switching are set based on time, and a switching stability control mechanism is introduced, whereby stable low-power operation may be ensured. Therefore, the present disclosure dynamically optimizes LP-WUS- and PEI-based dual subgrouping according to network conditions and terminal characteristics, thereby overcoming the limitations of an existing fixed subgrouping method and achieving excellent power efficiency and improved paging performance in various wireless communication systems, including IoT environments.

As described above, although the present disclosure has been described based on specific details such as detailed components and a limited number of embodiments and drawings, the embodiments are merely provided for easy understanding of the entire disclosure, the present disclosure is not limited thereto, and those skilled in the art will practice various changes and modifications from the above description.

Accordingly, the spirit of the present disclosure should not be construed as being limited to the above-described embodiments, and the entire scope of the appended claims and their equivalents should be understood as defining the scope and spirit of the present disclosure.

What is claimed is:

1. A wireless communication method performed by a user equipment (UE), comprising:
receiving, by the UE, a wake-up signal (WUS) configuration; and
monitoring a WUS associated with an ID of a Low Power (LP)-WUS subgroup to which the UE belongs, based on the WUS configuration,
wherein the ID of the LP-WUS subgroup is determined based on a UE_ID of the UE and a predefined number for power saving for each time period (T).

2. The wireless communication method of claim 1, wherein the ID of the LP-WUS subgroup (SubgroupID_{LP-WUS}) is determined based on Equation (1) below:
$$\begin{matrix}{SubgroupID}_{LP - WUS} = ( ⌊ \frac{UE\_ID}{N \cdot {N}_{s} \cdot {K}_{dyn}} ⌋ mod subgroupsNumForUEID\_LP - WUS ) \\ + ( subgroupsNumPerPO\_LP - WUS \\ - subgroupsNumForUEID\_LP - WUS )\end{matrix} \qquad ( 1 )$$
where N denotes a total number of paging frames during T, N_{S} denotes a number of paging occasions (POs) for one paging frame, subgroupsNumForUEID_LP-WUS denotes a number of WUS subgroups for UE_ID-based subgrouping in one PO, subgroupsNumPerPO_LP-WUS denotes a total number of available WUS subgroups for one PO, and K_{dyn} is a parameter determined based on a number of UEs within a current cell boundary, the number for power saving, and a number of UEs paged during T.

3. The wireless communication method of claim 2, wherein K_{dyn} is determined based on Equation (2) below:
$${K}_{dyn} = ⌈ \frac{C \cdot D}{U} ⌉ \qquad ( 2 )$$
where C denotes the number of UEs within the current cell boundary, D denotes the number for power saving, and U denotes the number of UEs paged during T.

4. The wireless communication method of claim 1, wherein a number of LP-WUS subgroups is dynamically adjusted for each time period (T).

5. The wireless communication method of claim 4, wherein the number of LP-WUS subgroups is determined based on a number of UEs that are active in a cell during T.

6. The wireless communication method of claim 5, wherein a number of WUS subgroups at a time point T (N_{SG}(T)) is determined based on Equation (3) below:
$${N}_{SG} ( T ) = ⌈ \frac{{C}_{T} \cdot {W}_{T}}{{U}_{opt}} ⌉ \qquad ( 3 )$$
where Uₒₚₜ denotes a predefined optimal number of UEs per subgroup, C_{T} denotes the number of UEs that are active in the cell measured at the time point T, and W_{T} denotes a preset power optimization weight for each time point (T).

7. The wireless communication method of claim 6, wherein the ID of the LP-WUS subgroup (SubgroupID_{LP-WUS}) is determined based on Equation (4) below:
SubgroupID_{LP-WUS}=(Hash(UE_ID+T+D_{T})mod N_{SG}(T)) (4)
where D_{T} denotes a predefined number for power saving at the time point T, and Hash( ) is a hash function.

8. The wireless communication method of claim 1, wherein a Physical-layer Early Indication (PEI) subgroup to which the UE belongs is dynamically determined.

9. The wireless communication method of claim 8, wherein the PEI subgroup is determined independently of the LP-WUS subgroup.

10. The wireless communication method of claim 8, wherein the PEI subgroup is dynamically determined for each time period based on at least one of a historical traffic frequency, a DRX cycle and an RRC state history, a mobility pattern of the UE, a service type, a QoS profile, a paging frequency, a wake-up log, UE location stability, capability information of the UE, or time-period-based traffic characteristics, or a combination thereof.

11. A wireless communication method performed by a base station, comprising:
transmitting a wake-up signal (WUS) configuration to a user equipment (UE); and
transmitting, based on the WUS configuration, a WUS associated with an ID of a Low Power (LP)-WUS subgroup to which the UE belongs,
wherein the ID of the LP-WUS subgroup is determined based on a UE_ID of the UE and a predefined number for power saving for each time period (T).

12. The wireless communication method of claim 11, wherein the ID of the LP-WUS subgroup (SubgroupID_{LP-WUS}) is determined based on Equation (1) below:
$$\begin{matrix}{SubgroupID}_{LP - WUS} = ( ⌊ \frac{UE\_ID}{N \cdot {N}_{s} \cdot {K}_{dyn}} ⌋ mod subgroupsNumForUEID\_LP - WUS ) \\ + ( subgroupsNumPerPO\_LP - WUS \\ - subgroupsNumForUEID\_LP - WUS )\end{matrix} \qquad ( 1 )$$
where N denotes a total number of paging frames during T, N_{S} denotes a number of paging occasions (POs) for one paging frame, subgroupsNumForUEID_LP-WUS denotes a number of WUS subgroups for UE_ID-based subgrouping in one PO, subgroupsNumPerPO_LP-WUS denotes a total number of available WUS subgroups for one PO, and K_{dyn} is a parameter determined based on a number of UEs within a current cell boundary, the number for power saving, and a number of UEs paged during T.

13. The wireless communication method of claim 12, wherein K_{dyn} is determined based on Equation (2) below:
$${K}_{dyn} = ⌈ \frac{C \cdot D}{U} ⌉ \qquad ( 2 )$$
where C denotes the number of UEs within the current cell boundary, D denotes the number for power saving, and U denotes the number of UEs paged during T.

14. The wireless communication method of claim 11, wherein a number of LP-WUS subgroups is dynamically adjusted for each time period (T).

15. The wireless communication method of claim 14, wherein the number of LP-WUS subgroups is determined based on a number of UEs that are active in a cell during T.

16. The wireless communication method of claim 15, wherein a number of WUS subgroups at a time point T (N_{SG}(T)) is determined based on Equation (3) below:
$${N}_{SG} ( T ) = ⌈ \frac{{C}_{T} \cdot {W}_{T}}{{U}_{opt}} ⌉ \qquad ( 3 )$$
where Uₒₚₜ denotes a predefined optimal number of UEs per subgroup, C_{T} denotes the number of UEs that are active in the cell measured at the time point T, and W_{T} denotes a preset power optimization weight for each time point T.

17. The wireless communication method of claim 16, wherein the ID of the LP-WUS subgroup (SubgroupID_{LP-WUS}) is determined based on Equation (4) below:
SubgroupID_{LP-WUS}=(Hash(UE_ID+T+D_{T})mod N_{SG}(T)) (4)
where D_{T} denotes a predefined number for power saving at the time point T, and Hash( ) is a hash function.

18. The wireless communication method of claim 11, wherein a Physical-layer Early Indication (PEI) subgroup to which the UE belongs is dynamically determined.

19. The wireless communication method of claim 18, wherein the PEI subgroup is dynamically determined for each time period based on at least one of a historical traffic frequency, a DRX cycle and an RRC state history, a mobility pattern of the UE, a service type, a QoS profile, a paging frequency, a wake-up log, UE location stability, capability information of the UE, or time-period-based traffic characteristics, or a combination thereof.

20. A user equipment for wireless communication, comprising:
a Main Radio (MR) receiver for receiving a wake-up signal (WUS) configuration from a base station;
a Low Power (LP) receiver for receiving a WUS from the base station; and
a control unit for monitoring a WUS associated with an ID of an LP-WUS subgroup to which the user equipment (UE) belongs, based on the WUS configuration,
wherein the ID of the LP-WUS subgroup is determined based on a UE_ID of the UE and a predefined number for power saving for each time period (T).
